(19) United States
(12) Patent Application Publication
(10) Pub. No.: US 2025/0077231 A1
(43) Pub. Date: Mar. 6, 2025

(54) METHOD FOR DISPLAYING INFORMATION, COMPUTER DEVICE AND STORAGE MEDIUM

(71) Applicant: Beijing Zitiao Network Technology Co., Ltd., Beijing (CN)

(72) Inventors: Aonan TAN, Beijing (CN); Rendan PAN, Beijing (CN); Jun LI, Beijing (CN); Mengna TONG, Beijing (CN)

(21) Appl. No.: 18/797,496

(22) Filed: Aug. 7, 2024

(30) Foreign Application Priority Data
Aug. 29, 2023 (CN) 202311101710.9

(51) Int. Cl. G06F 9/30; G06F 11/07

(52) U.S. Cl. CPC G06F 9/30181; G06F 11/0736; G06F 11/0769

(57) ABSTRACT

A method for displaying information, a computer device and a storage medium are provided. The method includes: in response to receiving questioning information on a dialog page, displaying a generated result content in an answer result matched with the questioning information according to a generation progress of the answer result; in a process of displaying the generated result content, stopping generating the answer result in response to receiving a generation stopping instruction; and in response to acquiring an answer result modification instruction, displaying an updated answer result, the updated answer result being obtained by modifying the answer result according to a target content question under a question dimension indicated by the answer result modification instruction.

### CROSS-REFERENCE TO RELATED APPLICATION

The present application claims the priority of the Chinese patent application No. 202311101710.9 filed on Aug. 29, 2023, and the content disclosed in the above Chinese patent application is cited in its entirety as a part of the present application.

### TECHNICAL FIELD

The present disclosure relates to a method for displaying information, a computer device, and a storage medium.

### BACKGROUND

With the rapid development of artificial intelligence technology, users may get answer results from models by talking with various models in the intelligent dialog application interface. In some cases, the answer results provided by the models may have the problem of poor answer effects. In order to solve this problem, the users often need to reorganize and enter questions to try to get expected answer results.

However, the new answer results acquired in this way still often have the problem of poor answer effects, resulting in unsatisfactory answers to the same question many times. Therefore, how to improve the rationality of the answer result for the second time has become an urgent problem to be solved.

### SUMMARY

Embodiments of the present disclosure at least provides a method and an apparatus for displaying information, a computer device, and a storage medium.

Embodiments of the present disclosure provides a method for displaying information, including:
in response to receiving questioning information on a dialog page, displaying a generated result content in an answer result matched with the questioning information according to a generation progress of the answer result;
in a process of displaying the generated result content, stopping generating the answer result in response to receiving a generation stopping instruction; and
in response to acquiring an answer result modification instruction, displaying an updated answer result, the updated answer result being obtained by modifying the answer result according to a target content question under a question dimension indicated by the answer result modification instruction.

In one possible implementation, the answer result modification instruction is acquired according to the following steps:
in response to receiving the generation stopping instruction, displaying content processing identifiers under different question dimensions, the content processing identifier under each question dimension being used for guiding and pointing out a content question of the generated result content currently displayed under the question dimension; and
in response to triggering any of the content processing identifiers, acquiring the target content question under the question dimension corresponding to the content processing identifier, and generating the answer result modification instruction according to the target content question.

In one possible implementation, the answer result modification instruction is acquired according to the following steps:
acquiring inputted content modification information, and determining a question dimension and a target content question according to the content modification information; and
generating an answer result modification instruction according to the question dimension and the target content question.

In one possible implementation, the question dimension includes a question understanding dimension, and the content processing identifier includes a first processing identifier under the question understanding dimension;
the acquiring the target content question under the question dimension corresponding to the content processing identifier includes:
displaying the questioning information in a dialog box of the dialog page;
acquiring edited and updated questioning information in response to an editing operation for the questioning information in the dialog box; and taking the updated questioning information as the target content question under
the question understanding dimension.

In one possible implementation, the question dimension includes a content error
dimension for the answer content, and the content processing identifier includes a second processing identifier under the content error dimension;
the acquiring the target content question under the question dimension corresponding to the content processing identifier includes:
acquiring inputted error content information according to first error input prompt information in the dialog box of the dialog page, and determining a target content question according to the error content information and the content error dimension.

In one possible implementation, the question dimension includes a content redundancy dimension for the answer content, and the content processing identifier includes a third processing identifier under the content redundancy dimension;
the acquiring the target content question under the question dimension corresponding to the content processing identifier includes:
acquiring a content redundancy question under the content redundancy dimension, and taking the content redundancy question as a target content question under the content redundancy dimension;
the displaying an updated answer result includes:
displaying a default answer result, the default answer result being pre-generated for the content redundancy question; and
displaying the generated result content in the updated answer result according to a generation progress of the updated answer result, the generated result content in the updated answer result being obtained by performing content simplification on the answer result according to the content redundancy question.

In one possible implementation, before displaying the updated answer result, the method further includes:
displaying preset answer information matched with the triggered content processing identifier below the displayed generated result content.

Embodiments of the present disclosure provide an apparatus for displaying information, including:
a first display module, configured to in response to receiving questioning information on a dialog page, display a generated result content in an answer result matched with the questioning information according to a generation progress of the answer result; in a process of displaying the generated result content, stop generating the answer result in response to receiving a generation stopping instruction; and
a second display module, in response to acquiring an answer result modification instruction, display an updated answer result, the updated answer result being obtained by modifying the answer result according to a target content question under a question dimension indicated by the answer result modification instruction.

An optional implementation of the present disclosure further provides a computer device, including: at least one processor and at least one memory, wherein the at least one memory stores machine-readable instructions executable by the at least one processor, and the at least one processor is used for executing the machine-readable instructions stored in the at least one memory; when the machine-readable instructions are executed by the at least one processor, the at least one processor executes the above method for displaying information and any possible implementation of the above method for displaying information.

An optional implementation of the present disclosure provides a non-transient computer-readable storage medium, wherein the non-transient computer-readable storage medium has stored thereon a computer program, and when the computer program is run by a computer device, the computer device executes the above method for displaying information and any possible implementation of the above method for displaying information.

The description of the effects of the apparatus for displaying information, the computer device, and the computer-readable storage medium mentioned above can be found in the description of the method for displaying information mentioned above, which will not be repeated here.

### BRIEF DESCRIPTION OF DRAWINGS

In order to provide a clearer explanation of the technical solution of the embodiments of the present disclosure, a brief introduction will be given below to the accompanying drawings required in the embodiments. The accompanying drawings are incorporated into the specification and form a part of the specification. These drawings illustrate embodiments that comply with the present disclosure and are used together with the specification to illustrate the technical solution of the present disclosure. It should be understood that the following drawings only illustrate certain embodiments of the present disclosure, and therefore should not be regarded as limiting the scope. For those skilled in the art, other relevant drawings can be obtained based on these drawings without creative efforts.

FIG. 1 shows a flowchart of a method for displaying information provided by an embodiment of the present disclosure;

FIG. 2 shows a schematic diagram of a displayed generated result content provided by an embodiment of the present disclosure;

FIG. 3 shows a schematic diagram of the display of stopping generating an answer result provided by an embodiment of the present disclosure;

FIG. 4 shows a schematic diagram of a page after triggering a first processing identifier provided by an embodiment of the present disclosure;

FIG. 5 shows a schematic diagram of a page after triggering a second processing identifier provided by an embodiment of the present disclosure;

FIG. 6 shows a schematic diagram of a page after triggering a third processing identifier provided by an embodiment of the present disclosure;

FIG. 7 shows a schematic diagram of an apparatus for displaying information provided by an embodiment of the present disclosure; and

FIG. 8 shows a schematic structural diagram of a computer device provided by an embodiment of the present disclosure.

### DETAILED DESCRIPTION

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are only a part of the embodiments of the present disclosure, not all of them. Generally, the components of the embodiments of the present disclosure described and shown here can be arranged and designed in various different configurations. Therefore, the following detailed description of the embodiments of the present disclosure is not intended to limit the scope of the claimed protection, but only to represent the selected embodiments of the present disclosure. Based on the embodiments of the present disclosure, all other embodiments obtained by those skilled in the art without creative efforts fall within the scope of protection of the present disclosure.

In addition, the terms “first”, “second”, etc. in the description and claims of the present disclosure, as well as the accompanying drawings, are used to distinguish similar objects and do not necessarily need to be used to describe a specific order or sequence. It should be understood that the data used in this way can be interchanged in appropriate cases, so that the embodiments described here can be implemented in order other than those illustrated or described here.

The term “a plurality or several” mentioned herein refers to two or more. “And/or” describes the association relationship of the associated object, indicating that there can be three types of relationships, for example, A and/or B can represent: the existence of A alone, the coexistence of A and B, and the existence of B alone. The character “/”' generally indicates that the related object before and after is an “or” relationship.

Through research, it has been found that with the rapid development of artificial intelligence models, various intelligent dialog models begin to appear, these models can understand information inputted by users and give corresponding answers. However, because the information inputted by the user is complex and changeable, there will always be cases where the answers provided by the model do not meet the expectations of the user. At this time, the user often needs to adjust the input information and re-enter it to acquire a new answer result. However, this method still often leads to the problem of a poor answer effect, which affects a dialog effect.

Based on the above research, the present disclosure provides a method and apparatus for displaying information, a computer device, and a storage medium. By displaying generated result contents according to a generation progress, the displaying answer results in real time can be implemented, and the problem that the waiting time is too long because it takes a long time to generate the answer results and needs to wait for all the answer results to be displayed is solved. In a process of generating the generated result content, in response to receiving the generation stopping instruction, it is possible to control to stop generating the answer result at any time, so that the control flexibility is improved. Since the answer result modification instruction indicates the target content question under the question dimension, the acquired answer result modification instruction can be used to modify the answer result, and targeted modification of the target content question existing in a current generation process can be realized, thus obtaining a more reasonable and expected updated answer result and improving the answer effect of the answer for the second time. Moreover, by modifying the answer result with the aid of the answer result modification instruction, the reasonable modification of the answer result can be realized without re-entering the questioning information, which can improve the flexibility of modification, and improve the rationality of the answer result obtained by the answer for the second time.

The shortcomings of the above solution are the results obtained by the inventor after practice and careful study. Therefore, the discovery process of the above problems and the solutions proposed in the present disclosure below should be the contributions made by the inventor to the present disclosure in the course of the present disclosure.

It should be noted that like reference numbers and letters refer to like items in the following drawings, and thus, once an item is defined in one drawing, it need not be further defined or explained in subsequent drawings.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For the convenience of understanding this embodiment, firstly, a method for displaying information disclosed in this embodiment of the present disclosure is introduced in detail. An execution subject of the method for displaying information provided in this embodiment of the present disclosure is generally a terminal device or other processing device with certain computing power, where the terminal device may be user equipment (UE), a mobile device, a user terminal, a terminal, a personal digital assistant (PDA), a handheld device, a computer device, etc. In some possible implementations, the method for displaying information can be implemented by a processor calling computer-readable instructions stored in a memory.

The method for displaying information provided by the embodiment of the present disclosure will be described by taking the execution subject as a terminal, for example.

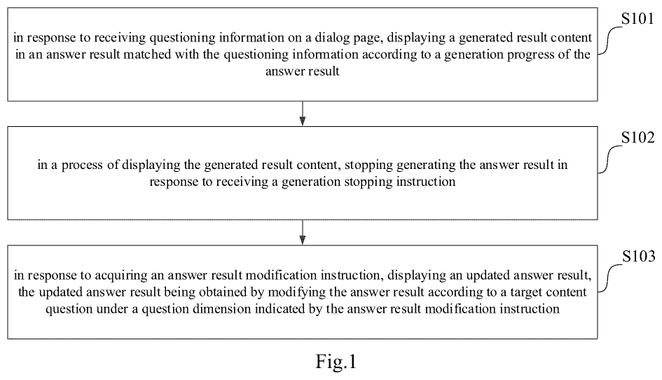

As shown in FIG. 1, a flowchart of a method for displaying information provided by an embodiment of the present disclosure may include the following steps:

S101: in response to receiving questioning information on a dialog page, displaying a generated result content in an answer result according to a generation progress of the answer result matched with the questioning information.

Here, the dialog page is a corresponding page of any intelligent dialog application, and the user can implement a dialog with the artificial intelligence model on the dialog page. The questioning information may be information inputted by the user according to the question requirements, and the answer result that meets the question requirements is expected to be acquired by inputting the questioning information into the dialog page. For example, the questioning information may be “Generate an article about XX”, “How to solve the XX problem” and so on. The questioning information may be information in any format, such as information in a text format, information in a picture format, information in a graphic format, information in a video format, information in a table document format, etc.

The answer result matched with the questioning information may be a result outputted by the artificial intelligence model for answering the questioning information, and the answer result provided by the artificial intelligence model may also be a result in any format, such as a text format, a picture format, a graphic format, a document format, a video format, etc.

When the artificial intelligence model generates the answer result, the answer result may be generated by sucking step by step, so that there is a generation progress of the answer result. For example, when the answer result is an article, the article may be generated word by word; and when the answer result is a video, the video may be generated frame by frame.

The generated result content is a partial answer result generated under the current generation progress, and when the generation progress reaches 100%, all the generated result contents constitute a complete answer result. For example, when the answer result is an article, whenever the artificial intelligence model generates a word or a phrase, the word or phrase may be displayed as the generated result content in the current generation progress. After the last word of the article is generated, the last word may be sequentially displayed behind the generated result content in order to obtain a complete article.

In a specific implementation, the user may input questioning information in a dialog box of a dialog page, and the terminal may send questioning information to the server in response to receiving the questioning information, the server uses the artificial intelligence model to identify and process the questioning information, and feeds back generated result contents to a terminal according to the generation progress of the answer result. The terminal may acquire the generated result contents fed back by the server according to the generation progress, and sequentially display the obtained generated result contents in the dialog page.

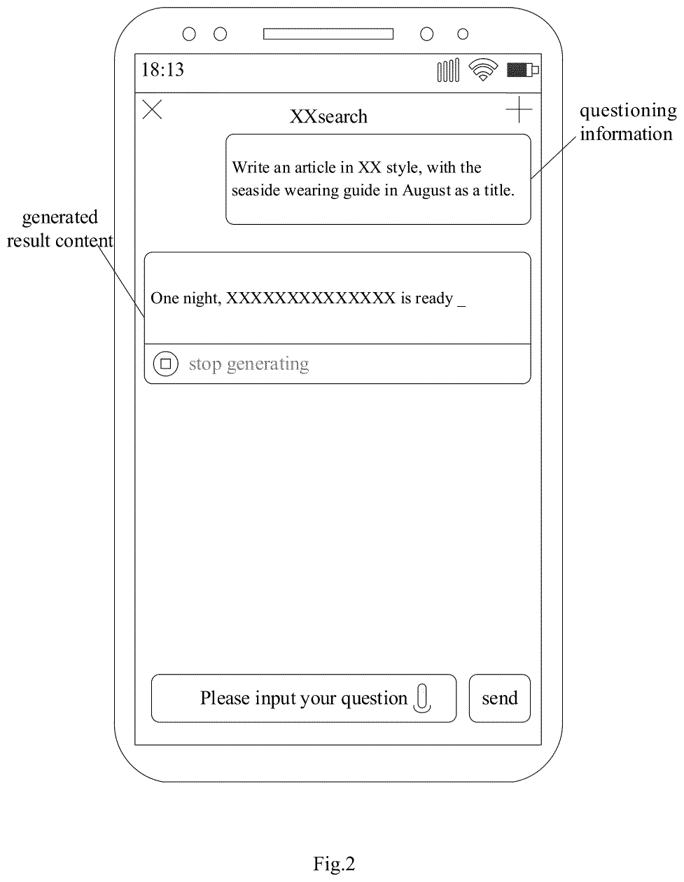

As shown in FIG. 2, it is a schematic diagram of a displayed generated result content provided by an embodiment of the present disclosure, where the questioning information inputted by the user is “Write an article in XX style, with the seaside wearing guide in August as a title”, and the generated result content displayed in sequence in the dialog page is “One night, XXXXXXX XXXXX is ready _”, where “_” indicates a display position of a result content to be generated next. Below the displayed generated result content, there is also a generation stopping identifier displayed. By triggering this identifier, the generation of the answer result can be stopped.

S102: in a process of displaying the generated result content, stopping generating the answer result in response to receiving a generation stopping instruction.

Here, since the displayed generated result content is determined according to the generated result content, a process of displaying the generated result content may also be considered as a process of generating the generated result content.

The generation stopping instruction may be acquired after the user triggers the generation stopping identifier in the dialog page, may also be inputted by the user in the dialog box, and may also be acquired after the user performs a preset operation. The generation stopping instruction is used to display that the generation of the answer result for the questioning information is stopped, and meanwhile, the display of a new generated result content is also stopped.

In a specific implementation, in the process of displaying the generated result content, if the generation stopping instruction is acquired, the display of the new generated result content may be stopped in response to the generation stopping instruction, and meanwhile, the generation stopping instruction may be fed back to the server, so that the server can stop generating the answer result. Since the server stops generating the answer result and the terminal also stops displaying any new generated result content, the terminal has stopped generating the answer result with respect to the user.

Meanwhile, after stopping generating the answer result, the terminal may display generation stopping prompt information at a preset position of the displayed generated result content. The generation stopping prompt information may be “having stopped generating”, for example.

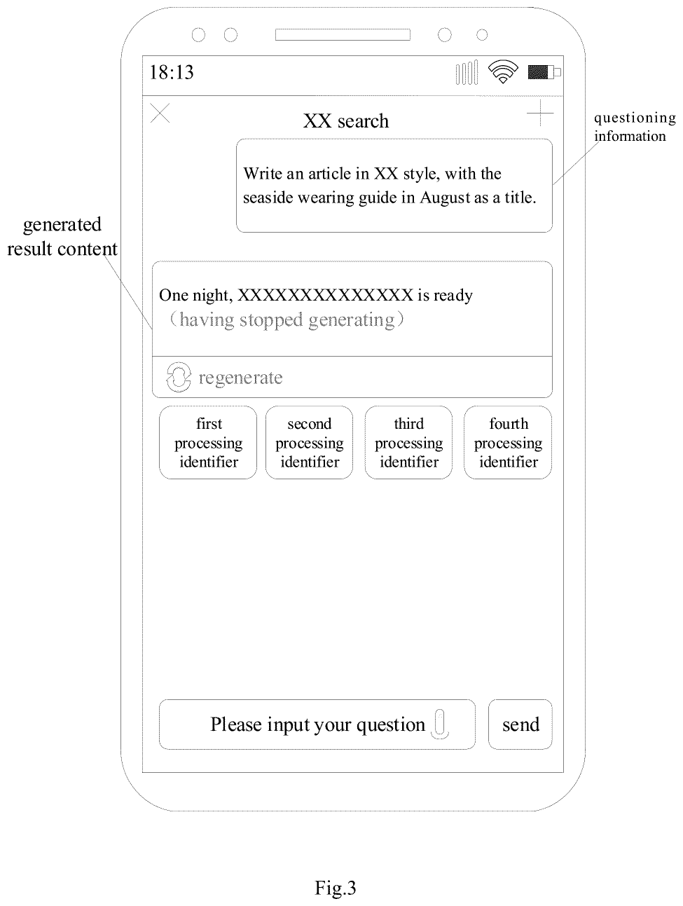

As shown in FIG. 3, it is a schematic diagram of the display of stopping generating an answer result provided by an embodiment of the present disclosure, where a generation stopping instruction may be received in response to the user clicking a “stop generating” identifier in FIG. 2, and then the page shown in FIG. 3 may be displayed in response to the instruction. In FIG. 3, after the generation of the answer result is stopped, generation stopping prompt information (that is, “having stopped generating” in FIG. 3) may be displayed, and the “stop generating” identifier may be updated to a “regenerate” identifier. The “regenerate” identifier, after being triggered, may regenerate an answer result matched with the questioning information. In addition, in FIG. 3, there are also a number of content processing identifiers displayed, and different content processing identifiers are used to guide and point out a content question of the generated result content currently displayed under this question dimension. About various content processing identifier, they will be introduced in detail later.

S103: in response to acquiring an answer result modification instruction, displaying an updated answer result, the updated answer result being obtained by modifying the answer result according to a target content question under a question dimension indicated by the answer result modification instruction.

Here, the answer result modification instruction is used to indicate a question dimension corresponding to the current generated result content and a target content question under this question dimension, and is also used to indicate to regenerate the answer result for the questioning information according to the answer result modification instruction. The target content question is a current question of the generated result content. For example, the question dimension indicated by the answer result modification instruction may be an information understanding dimension, and a target content question under this dimension may be “The generated answer result needs to fit an XX style and an XX subject”. The answer result modification instruction may be directly inputted in the dialog box or may also be acquired after the content processing identifier in the dialog page is triggered.

An updated answer result is an answer result regenerated according to the answer result modification instruction, based on the questioning information and the generated result content, and is still used to answer the questioning information. Specifically, the answer result modification instruction may affect a non-generated answer result while modifying the generated result content, and the updated answer result may be a new answer result obtained by affecting the generated result content and the non-generated answer result simultaneously according to the answer result modification instruction.

In a specific implementation, the terminal may send the answer result modification instruction to the server in response to acquiring the answer result modification instruction. After receiving the answer result modification instruction, the server may re-input the answer result modification instruction, the generated result content and the questioning information into the artificial intelligence model to obtain an updated answer result outputted by the artificial intelligence model, and send the updated answer result to the terminal. The terminal may display the updated answer result below the displayed generated result content.

Understandably, the updated answer result may also be generated step by step by the artificial intelligence model, so that the server can feed back the generated result contents in the updated answer result to the terminal sequentially according to the generation progress of the artificial intelligence model. Then, the terminal may display the generated result contents in the updated answer result on the dialog page sequentially according to the generation progress of the updated answer result until the artificial intelligence model generates all the updated answer results, and the terminal can display the complete updated answer results on the dialog page.

In an embodiment, the answer result modification instruction may be acquired in the following two methods:

Method one: acquiring inputted content modification information, and determining a question dimension and a target content question according to content modification information; and generating the answer result modification instruction according to the question dimension and the target content question.

Here, the content modification information may be modification indication information for the generated result contents inputted by the user in the dialog box. The question dimension may include, but is not limited to, a question understanding dimension, a content error dimension, a content redundancy dimension, and other dimensions. The specific question dimension may be set according to experience, which is not specifically limited in the embodiment of the present disclosure. The target content question is a question existing under the question dimension.

In a specific implementation, the modification indication information inputted by the user in the dialog box may be acquired, and the content modification information may be parsed to determine the question dimension indicated by the content modification information and the target content question under the question dimension. Understandably, the number of the parsed question dimensions may be one or multiple, and in the case of multiple question dimensions, the target content questions under the various question dimensions may be parsed. Thereafter, an answer result modification instruction including the question dimensions and the target content questions may be generated.

Optionally, in a process of inputting the content modification information by the user, a modification information format may also be displayed. For example, the modification information format may be “question dimension+content question”. In this way, the user may input the content modification information according to the modification information format. Thereafter, after acquiring the content modification information, the terminal may directly generate an answer result instruction including the content modification information.

Method two: step one, in response to receiving the generation stopping instruction, displaying content processing identifiers under different question dimensions, the content processing identifier under each question dimension being used for guiding and pointing out a content question of the generated result content currently displayed under the question dimension; and
step two, in response to triggering any of the content processing identifiers, acquiring the target content question under the question dimension corresponding to the content processing identifier, and generating the answer result modification instruction according to the target content question.

Here, the numbers of the specific question dimensions and question dimensions may be set according to the experience, which are not specifically limited in the embodiment of the present disclosure. Exemplarily, the question dimension may include a question understanding dimension, a content error dimension, a content redundancy dimension, and other dimensions, where the other dimensions are dimensions except the question understanding dimension, the content error dimension, and the content redundancy dimension. One question dimension corresponds to one content processing identifier, namely, the content processing identifier under each question dimension. It is used to guide the user to point out the content question of the currently displayed generated result content under the question dimension. For example, the content processing identifier under the question understanding dimension is used to guide the user to point out a question in understanding the questioning information reflected by the generated result content. The operation of triggering the content processing identifier may specifically be an operation of clicking the content processing identifier.

In a specific implementation, in response to the generation stopping instruction, the terminal may display the content processing identifiers respectively corresponding to the plurality of question dimensions while stopping generating and displaying the answer result. For example, in FIG. 3, it shows a content processing identifier corresponding to the question understanding dimension (i.e., a first processing identifier), a content processing identifier corresponding to the content error dimension (i.e., a second processing identifier), a content processing identifier corresponding to the content redundancy dimension (i.e., a third processing identifier) and content processing identifiers corresponding to other dimensions (i.e., a fourth processing identifier).

Thereafter, in response to the triggering operation of the user for any content processing identifier, the target content question under the question dimension corresponding to the content processing identifier may be acquired, and the answer result modification instruction may be generated according to the target content question. For example, a default target content question may be preset for each content processing identifier, and in response to the user triggering the content processing identifier, the default target content question corresponding to the content processing identifier may be acquired, and an answer result modification instruction including the target content question and the question dimension corresponding to the content processing identifier may be generated. Or, for each content processing identifier, an answer result modification instruction corresponding to the content processing identifier may be set in advance, and in response to triggering the content processing identifier, the answer result modification instruction set for the content processing identifier may be directly acquired.

In an embodiment, if the question dimension includes a question understanding dimension, the content processing identifier may include a first processing identifier under the question understanding dimension. For example, the first processing identifier may be an “I don't understand the question” identifier. The first processing identifier is used to guide and point out the content question existing in understanding the questioning information of the currently displayed generated result content. In this case, the step of “acquiring the target content question under the question dimension corresponding to the content processing identifier” in the above step two may be implemented according to the following steps:

S1: displaying the questioning information in a dialog box of the dialog page.

In a specific implementation, the questioning information inputted by the user may be displayed in the dialog box of the dialog page in response to triggering the first processing identifier.

S2: acquiring edited and updated questioning information in response to an editing operation for the questioning information in the dialog box.

Here, the editing operation is an operation of editing the questioning information in the dialog box, such as deleting the content in the questioning information, adding the content in the questioning information, etc. The updated questioning information is information obtained after editing the questioning information.

Exemplarily, the user can edit the questioning information in the dialog box, and the terminal may acquire the updated questioning information edited by the user in response to the editing operation.

S3: taking the updated questioning information as the target content question under the question understanding dimension.

Exemplarily, after acquiring the updated questioning information, the terminal may take the updated questioning information as the target content question pointed out by the user under the question understanding dimension. Thereafter, according to the target content question and the question understanding dimension, the answer result modification instruction may be generated to modify the answer result, so as to obtain the updated answer result.

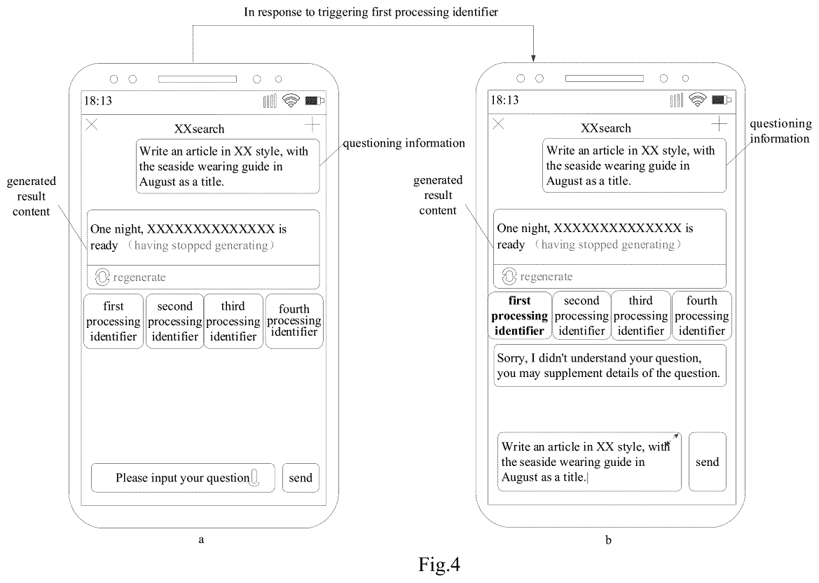

As shown in FIG. 4, it is a schematic diagram of a page after triggering a first processing identifier provided by the embodiment of the present disclosure, where “a” in FIG. 4 is the page shown in FIG. 3, “b” in FIG. 4 is the page displayed in response to triggering the first processing identifier in FIG. 3, and the questioning information is displayed in the dialog box in “b”. After the user edits the questioning information, the terminal acquires the updated questioning information. For example, the updated questioning information may be “write an article in XX style, with the seaside wearing guide in August as the title, and the generated answer result needs to fit the XX style and the XX subject without XX information”. Thereafter, the updated questioning information may be taken as the target content question under the question understanding dimension, and the answer result modification instruction may be generated according to the updated questioning information and the question understanding dimension. In response to triggering a sending identifier in the dialog box, the answer result modification instruction is sent to the server, so that the server can use the artificial intelligence model to output an updated answer result according to the answer result modification instruction. Meanwhile, after the sending identifier is sent, the updated questioning information may be displayed in the dialog page.

In an embodiment, when the question dimension includes the content error dimension for the answer content, the content processing identifier may include a second processing identifier under the content error dimension. The answer content is the displayed generated result content. For example, the second processing identifier may be a “serious error occurred” identifier. The second processing identifier is used to guide and point out the content question in the generated result content currently displayed, such as wrongly written characters, unsmooth sentences, sensitive information contained and the like. In this case, the step of “acquiring the target content question under the question dimension corresponding to the content processing identifier” in the above step two may be implemented according to the following steps:
acquiring inputted error content information according to first error input prompt information in the dialog box of the dialog page, and determining a target content question according to the error content information and the content error dimension.

Here, the first error input prompt information is used to prompt an error question in the inputted generated result content. For example, the first error input prompt information may be “The error of the above answer is:”.

The error content information is error information determined from the generated result content and inputted by the user.

In a specific implementation, the first error input prompt information may be displayed in the dialog box in response to triggering the second processing identifier. Then, the error content information inputted by the user according to the first error input prompt information may be acquired in response to the user's input operation in the dialog box. Thereafter, the error content information may be sorted out according to the content error dimension to obtain the target content question. For example, an information format corresponding to the content error dimension may be set in advance, and after the error content information is obtained, a format of the error content information may be adjusted according to the information format to obtain the target content question.

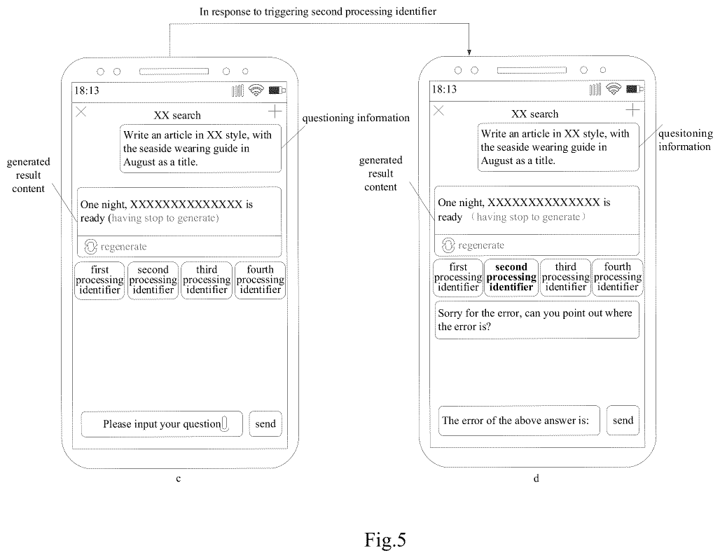

As shown in FIG. 5, it is a schematic diagram of a page after triggering a second processing identifier provided by the embodiment of the present disclosure, where “c” in FIG. 5 is the page shown in FIG. 3, “d” in FIG. 5 is the page displayed in response to triggering the second processing identifier in FIG. 3, and the first error input prompt information is displayed in the dialog box in “d” (that is, “The error of the above answer is:”). Then, the error content information inputted by the user in the dialog box may be acquired and the target content question is determined based on the error content information. Thereafter, the answer result modification instruction may be generated according to the target content question. In response to triggering a sending identifier in the dialog box, the answer result modification instruction is sent to the server, so that the server can use the artificial intelligence model to output an updated answer result according to the answer result modification instruction. Meanwhile, in response to triggering the sending identifier, the error content information may be displayed in the dialog page.

In an embodiment, when the question dimension includes the content redundancy dimension for the answer content, the content processing identifier may include a third processing identifier under the content redundancy dimension. The answer content is the displayed generated result content. For example, the third processing identifier may be a “question has been solved” identifier or a “result is capable of being simplified” identifier, etc. In this case, the step of “acquiring the target content question under the question dimension corresponding to the content processing identifier” in the above step two may be implemented according to the following steps:
acquiring a content redundancy question under the content redundancy dimension, and taking the content redundancy question as a target content question under the content redundancy dimension.

Here, the content redundancy question may be a question set for the content redundancy dimension in advance, for example, the content redundancy question may be “there is redundancy in the current answer, please simplify”; or the content redundancy question may also be a redundancy question specifically inputted by the user in the dialog box, for example, there is redundancy in the xth sentence of the current answer”.

Exemplarily, the default content redundancy question may be acquired in response to the user triggering the third processing identifier, and the content redundancy question may be taken as the target content question under the content redundancy dimension. Thereafter, an answer result modification instruction may be generated according to the target content question, and the answer result modification instruction is fed back to the server, so as to acquire an updated answer result fed back by the server and outputted according to the answer result modification instruction by using the artificial intelligence model.

Further, for the step of displaying the updated answer result, it may be implemented according to the following steps:
displaying a default answer result, the default answer result being pre-generated for the content redundancy question.

Here, the default answer result may be pre-generated for the content redundancy question, that is, the default answer result which is matched with the third processing identifier can be set in advance. After the user triggers the third processing identifier, the default answer result can be acquired first and displayed in the dialog page.

Displaying the generated result content in the updated answer result according to a generation progress of the updated answer result, the generated result content in the updated answer result being obtained by performing content simplification on the answer result according to the content redundancy question.

In a specific implementation, after the answer result modification instruction is sent to the server, the generated result content in the updated answer result fed back by the server according to the generation progress of the updated answer result may be acquired. The generated result content in the updated answer result is obtained by simplifying the answer result according to the content redundancy question by using the artificial intelligence model. The generated result content in the updated answer result may be displayed below the default answer result.

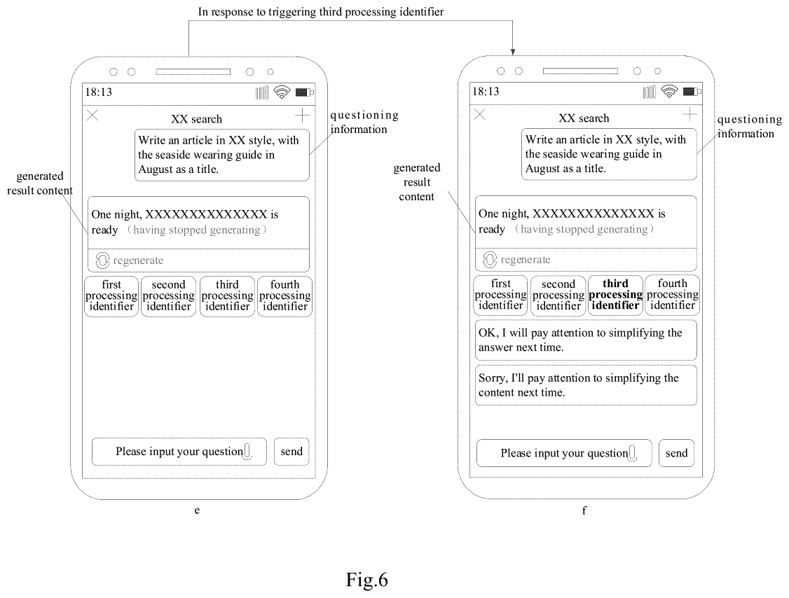

As shown in FIG. 6, it is a schematic diagram of a page after triggering a third processing identifier provided by the embodiment of the present disclosure, where “e” in FIG. 6 is the page shown in FIG. 3, and “f” in FIG. 6 is the page displayed in response to triggering the third processing identifier in FIG. 3. Meanwhile, the default answer result is displayed in “f” (that is, “OK, I will pay attention to simplifying the answer next time”), which can be displayed in response to triggering the third processing identifier. Thereafter, after sending the answer result modification instruction generated based on the content redundancy question to the server, the generated result content fed back by the server according to the generation progress of the updated answer result may be acquired and displayed in the dialog page.

Optionally, after the user triggers the third processing identifier, the default answer result can be directly displayed in the dialog page as the updated answer result.

In an embodiment, when the question dimension includes other dimensions, the content processing identifier may include a fourth processing identifier in other dimensions (e.g., the “other” identifier in FIG. 3). In this case, in response to the user triggering the fourth processing identifier, various question information inputted by the user in the dialog box for the content of the answered result may be acquired, the question information may be used as the target answer question, and an answer result modification instruction including the target answer question may be generated. Thereafter, the answer result modification instruction may be sent to the server, so that the server can use the artificial intelligence model to modify the answer result according to each question information in the answer result modification instruction, and output the updated answer result.

In an embodiment, before displaying the updated answer result, the following step may be performed:
displaying preset answer information matched with the triggered content processing identifier below the displayed generated result content.

Here, for each content processing identifier, preset answer information, preset answer information corresponding to each content processing identifier and a question dimension corresponding to the content processing identifier may be set for a memory processing identifier in advance. For example, the preset answer information corresponding to the first processing identifier may be “Sorry, I didn't understand your question, you may supplement details of the question”; the preset answer information corresponding to the second processing identifier may be “Sorry for the error, can you point out where the error is?”; the preset answer information corresponding to the third processing identifier may be “Sorry, I'll pay attention to simplifying the content next time”; and the preset answer information corresponding to the fourth processing identifier may be “Sorry for not giving the desired answer, can you point out where the problem is?”

Specifically, after the content processing identifier is triggered, the preset answer information corresponding to the content processing identifier may be acquired, and the preset answer information may be displayed below the displayed generated result content. For example, in “b” of FIG. 4, the preset answer information corresponding to the first processing identifier is displayed (that is, “Sorry, I didn't understand your question, you may supplement details of the question”); in “d” of FIG. 5, the preset answer information corresponding to the second processing identifier is displayed (that is, “Sorry for the error, can you point out where the error is?”); and in “f” of FIG. 6, the preset answer information corresponding to the third processing identifier is displayed (that is, “Sorry, I'll pay attention to simplifying the content next time”).

In an embodiment, in order to improve the answer effect of the artificial intelligence model, the artificial intelligence model can also be trained by using the questioning information and the updated answer result. Specifically, a plurality of questioning information, an updated answer result corresponding to each questioning information and evaluation information of the updated answer result may be acquired. The evaluation information may be, for example, a scoring score, giving information, and defriending information. The questioning information is inputted into the artificial intelligence model, and the predicted answer result outputted by the artificial intelligence model is acquired. Here, the predicted answer result may be consistent with the answer result outputted by the artificial intelligence model for the questioning information without receiving the generation stopping instruction.

Then, according to the evaluation information of the updated answer result, the updated answer result and the predicted answer result corresponding to the questioning information, a predicted loss of the artificial intelligence model may be determined, the artificial intelligence model is iteratively trained by using the predicted loss until a preset training stop condition is met, and the updated artificial intelligence model is obtained. Thereafter, the updated artificial intelligence model may be used to output an answer result for questioning information newly inputted by the user. The preset training stop condition may be that a number of rounds of iterative training reaches a preset number of rounds and/or the prediction accuracy of the trained artificial intelligence model reaches the preset accuracy.

Based on the above embodiments, by displaying generated result contents according to a generation progress, displaying the answer results in real time can be implemented, and the problem that the waiting time is too long because it takes a long time to generate the answer results and needs to wait for all the answer results to be displayed is solved. In a process of generating the generated result content, in response to receiving the generation stopping instruction, it is possible to control to stop generating the answer result at any time, so that the control flexibility is improved. Since the answer result modification instruction indicates the target content question under the question dimension, the acquired answer result modification instruction can be used to modify the answer result, and targeted modification of the target content question existing in a current generation process can be realized, thus obtaining a more reasonable and expected updated answer result and improving the answer effect of the answer for the second time. That is to say, based on the user's feedback on the generated result content, rapid correction to the answer result may be realized, thus shortening the time and path for the user to get a better answer result. Moreover, by modifying the answer result with the aid of the answer result modification instruction, the reasonable modification of the answer result can be realized without re-entering the questioning information, which can improve the flexibility of modification, and improve the rationality of the answer result obtained by the answer for the second time.

It can be understood by those skilled in the art that in the above-mentioned method of specific implementation, the order in which the steps are written does not imply a strict order of execution which constitutes any limitation to the implementation process, and the exact order in which the steps are executed should be determined by their functions and possible inherent logics.

Based on the same inventive concept, an embodiment of the present disclosure also provides an apparatus for displaying information corresponding to the method for displaying information. Since the apparatus in the embodiment of the present disclosure has similar principle of solving problems as the above-mentioned method for displaying information in the embodiment of the present disclosure, the implementation of the apparatus can refer to the implementation of the method, and the repeated parts are omitted here.

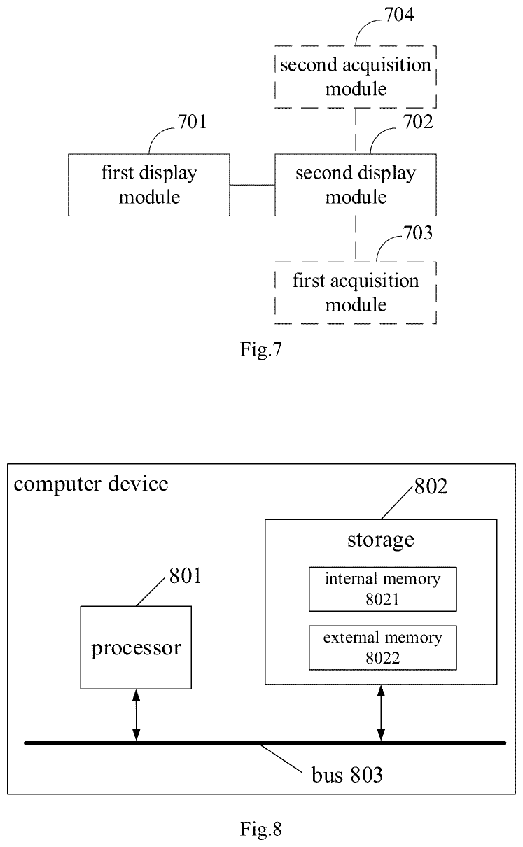

As shown in FIG. 7, it shows a schematic diagram of an apparatus for displaying information provided by an embodiment of the present disclosure, including:
a first display module 701, configured to: in response to receiving questioning information on a dialog page, display a generated result content matched with the questioning information in an answer result according to a generation progress of the answer result; and in a process of displaying the generated result content, stop generating the answer result in response to receiving a generation stopping instruction; and
a second display module 702, configured to: in response to acquiring an answer result modification instruction, display an updated answer result, the updated answer result being obtained by modifying the answer result according to a target content question under a question dimension indicated by the answer result modification instruction.

In a possible implementation, the apparatus further includes:
a first acquisition module 703, configured to acquire the answer result modification instruction according to the following steps:
in response to receiving the generation stopping instruction, displaying content processing identifiers under different question dimensions, the content processing identifier under each question dimension being used for guiding and pointing out a content question of the generated result content currently displayed under the question dimension; and
in response to triggering any of the content processing identifiers, acquiring the target content question under the question dimension corresponding to the content processing identifier, and generating the answer result modification instruction according to the target content question.

In a possible implementation, the apparatus further includes:
a second acquisition module 704, configured to acquire the answer result modification instruction according to the following steps:
acquiring inputted content modification information, and determining a question dimension and a target content question according to the content modification information; and
generating an answer result modification instruction according to the question dimension and the target content question.

In a possible implementation, the question dimension includes a question understanding dimension, and the content processing identifier includes a first processing identifier under the question understanding dimension;
the first acquisition module 703, when acquiring the target content question under the question dimension corresponding to the content processing identifier, is configured to:
display the questioning information in a dialog box of the dialog page;
acquire edited and updated questioning information in response to an editing operation for the questioning information in the dialog box; and
take the updated questioning information as the target content question under the question understanding dimension.

In a possible implementation, the question dimension includes a content error dimension for the answer content, and the content processing identifier includes a second processing identifier under the content error dimension;
the first acquisition module 703, when acquiring the target content question under the question dimension corresponding to the content processing identifier, is configured to:
acquire the target content question under the question dimension corresponding to the content processing identifier, which includes:
acquiring inputted error content information according to first error input prompt information in the dialog box of the dialog page, and determining a target content question according to the error content information and the content error dimension.

In a possible implementation, the question dimension includes a content redundancy dimension for the answer content, and the content processing identifier includes a third processing identifier under the content redundancy dimension;
the first acquisition module 703, when acquiring the target content question under the question dimension corresponding to the content processing identifier, is configured to:
acquire a content redundancy question under the content redundancy dimension, and take the content redundancy question as a target content question under the content redundancy dimension;
the second display module 702, when displaying the updated answer result, is configured to:
display a default answer result, the default answer result being pre-generated for the content redundancy question; and
display the generated result content in the updated answer result according to a generation progress of the updated answer result, the generated result content in the updated answer result being obtained by performing content simplification on the answer result according to the content redundancy question.

In a possible implementation, the second display module 702, before displaying the updated answer result, is further configured to:
display preset answer information matched with the triggered content processing identifier below the displayed generated result content.

The description of a processing flow of each module in the apparatus and an interaction flow between the modules may refer to the relevant description in the foregoing method embodiment, and will not be described in detail here.

Based on the same technical concept, an embodiment of the present application also provides a computer device. Referring to FIG. 8, it shows a structural schematic diagram of a computer device provided by an embodiment of the present application. The computer device includes:
a processor 801, a memory 802, and a bus 803, where the memory 802 stores machine-readable instructions executable by the processor 801, and the processor 801 is used for executing the machine-readable instructions stored in the memory 802. When the machine-readable instructions are executed by the processor 801, the processor 801 performs the following steps: S101: in response to receiving questioning information on a dialog page, displaying a generated result content in an answer result matched with the questioning information according to a generation progress of the answer result; S102: in a process of displaying the generated result content, stopping generating the answer result in response to receiving a generation stopping instruction; and S103: in response to acquiring an answer result modification instruction, displaying an updated answer result, the updated answer result being obtained by modifying the answer result according to a target content question under a question dimension indicated by the answer result modification instruction.

The storage 802 includes an internal memory 8021 and an external memory 8022. The internal memory 8021 here is also called an internal storage, which is used for temporarily storing operation data in the processor 801 and data exchanged with the external memory 8022 such as a hard disk. The processor 801 exchanges data with the external memory 8022 through the internal memory 8021, and when the computer device is running, the processor 801 is communicated with the memory 802 through the bus 803, so that the processor 801 executes the execution instructions mentioned in the foregoing method embodiment.

An embodiment of the present disclosure also provides a computer-readable storage medium having stored thereon a computer program which, when run by a processor, executes the steps of the method for displaying information described in the foregoing method embodiment. The storage medium may be a volatile or nonvolatile computer-readable storage medium.

The computer program product of the method for displaying information provided in embodiments of the present disclosure includes a computer-readable storage medium that stores program codes. The instructions included in the program code can be used to execute the steps of the method for displaying information described in the above method embodiment. The above method embodiment can be referred for details, which will not be repeated here.

The computer program product can be specifically implemented through a hardware, a software, or a combination thereof. In an optional embodiment, the computer program product is specifically embodied as a computer storage medium, while in another optional embodiment, the computer program product is specifically embodied as a software product, such as a Software Development Kit (SDK), etc.

Those skilled in the art can clearly understand that for the convenience and conciseness of the description, the specific operating process of the system and apparatus described above can refer to the corresponding process in the aforementioned method embodiments, which will not be repeated here. In the several embodiments provided in the present disclosure, it should be understood that the disclosed system, apparatus, and methods may be implemented in other ways. The apparatus embodiments described above are only illustrative. For example, the division of units is only a logical function division, and there may be other division methods in actual implementation. For example, multiple units or components can be combined or integrated into another system, or some features can be ignored or not executed. Another point is that the coupling or direct coupling or communication connection displayed or discussed between each other can be indirect coupling or communication connection through some communication interfaces, apparatuses, or units, which can be electrical, mechanical, or other forms.

The units described as separate components can be or may not be physically separated, and the components displayed as units can be or may not be physical units, that is, they can be located in one place or distributed across multiple network units. Some or all of the units can be selected according to actual needs to achieve the purpose of the embodiment.

In addition, each functional unit in the various embodiments of the present disclosure can be integrated into one processing unit, and can also exist physically separately, or two or more units can be integrated into one unit.

If the function is implemented in the form of a software functional unit and sold or used as an independent product, it can be stored in a non-volatile computer-readable storage medium that can be executed by a processor. Based on this understanding, the technical solution of the present disclosure can be embodied as a software product. The computer software product is stored in a storage medium and includes several instructions to enable a computer device (which can be a personal computer, server, or network device, etc.) to perform all or part of the steps of the methods described in the various embodiments of the present disclosure. The above-mentioned storage medium includes: a USB flash drive, a portable hard drive, Read Only Memory (ROM), Random Access Memory (RAM), a magnetic disk or a light disk, and other media that can store program codes.

If the technical solution of the present application involves personal information, the product applying the technical solution of the present application has been clearly informed of the personal information processing rules and obtained individual independent consent before processing the personal information. If the technical solution of the present application involves sensitive personal information, the product applying the technical solution of the present application has obtained individual independent consent before processing the sensitive personal information, and it also meets the requirements of “express consent”. For example, at personal information collection apparatuses such as a camera, a clear and obvious sign is provided to inform that an individual has enter a personal information collection range in which personal information will be collected, and if an individual voluntarily enters the collection range, it will be regarded as agreeing to collect his personal information; or on a personal information processing apparatus, under the condition that the personal information processing rules are informed by the obvious sign/information, personal authorization is obtained by pop-up information or asking individuals to upload their personal information by themselves, where the personal information processing rules may include a personal information processor, personal information processing purposes, processing methods, types of personal information processed and other information.

Finally, it should be noted that the above embodiments are only specific embodiments of the present disclosure, to illustrate the technical solution of the present disclosure, and not to limit it. The scope of protection of the present disclosure is not limited to this. Although detailed explanations of the present disclosure have been made with reference to the aforementioned embodiments, those skilled in the art should understand that any technical personnel familiar with the art can still modify or easily think of changes to the technical solution recorded in the aforementioned embodiments within the scope of the technology disclosed by the present disclosure, or replace some of the technical features equally; and these modifications, changes, or replacements do not make the essence of the corresponding technical solution deviate from the spirit and scope of the technical solution of the present disclosure, and should be covered within the scope of protection of the present disclosure. Therefore, the scope of protection of the present disclosure shall be based on the scope of protection of the claims.

1. A method for displaying information, comprising:
in response to receiving questioning information on a dialog page, displaying a generated result content in an answer result matched with the questioning information according to a generation progress of the answer result;
in a process of displaying the generated result content, stopping generating the answer result in response to receiving a generation stopping instruction; and
in response to acquiring an answer result modification instruction, displaying an updated answer result, the updated answer result being obtained by modifying the answer result according to a target content question under a question dimension indicated by the answer result modification instruction.

2. The method according to claim 1, wherein the answer result modification instruction is acquired according to the following steps:
in response to receiving the generation stopping instruction, displaying content processing identifiers under different question dimensions, the content processing identifier under each question dimension being used for guiding and pointing out a content question of the generated result content currently displayed under the question dimension; and
in response to triggering any of the content processing identifiers, acquiring the target content question under the question dimension corresponding to the content processing identifier, and generating the answer result modification instruction according to the target content question.

3. The method according to claim 1, wherein the answer result modification instruction is acquired according to the following steps:
acquiring inputted content modification information, and determining a question dimension and a target content question according to the content modification information; and
generating an answer result modification instruction according to the question dimension and the target content question.

4. The method according to claim 2, wherein the question dimension comprises a question understanding dimension, and the content processing identifier comprises a first processing identifier under the question understanding dimension;
the acquiring the target content question under the question dimension corresponding to the content processing identifier comprises:
displaying the questioning information in a dialog box of the dialog page;
acquiring edited updated questioning information in response to an editing operation for the questioning information in the dialog box; and
taking the updated questioning information as the target content question under the question understanding dimension.

5. The method according to claim 2, wherein the question dimension comprises a content error dimension for the answer content, and the content processing identifier comprises a second processing identifier under the content error dimension;
the acquiring the target content question under the question dimension corresponding to the content processing identifier comprises:
acquiring inputted error content information according to first error input prompt information in the dialog box of the dialog page, and determining a target content question according to the error content information and the content error dimension.

6. The method according to claim 2, wherein the question dimension comprises a content redundancy dimension for the answer content, and the content processing identifier comprises a third processing identifier under the content redundancy dimension;
the acquiring the target content question under the question dimension corresponding to the content processing identifier comprises:
acquiring a content redundancy question under the content redundancy dimension, and taking the content redundancy question as a target content question under the content redundancy dimension;
the displaying an updated answer result comprises:
displaying a default answer result, the default answer result being pre-generated for the content redundancy question; and
displaying the generated result content in the updated answer result according to a generation progress of the updated answer result, the generated result content in the updated answer result being obtained by performing content simplification on the answer result according to the content redundancy question.

7. The method according to claim 2, wherein before displaying the updated answer result, the method further comprises:
displaying preset answer information matched with the triggered content processing identifier below the displayed generated result content.

8. A computer device, comprising: at least one processor and at least one memory, wherein the at least one memory stores machine-readable instructions executable by the at least one processor, and the at least one processor is used for executing the machine-readable instructions stored in the at least one memory; when the machine-readable instructions are executed by the at least one processor, the at least one processor executes a method for displaying information display, which comprises:
in response to receiving questioning information on a dialog page, displaying a generated result content in an answer result matched with the questioning information according to a generation progress of the answer result;
in a process of displaying the generated result content, stopping generating the answer result in response to receiving a generation stopping instruction; and
in response to acquiring an answer result modification instruction, displaying an updated answer result, the updated answer result being obtained by modifying the answer result according to a target content question under a question dimension indicated by the answer result modification instruction.

9. The computer device according to claim 8, wherein the answer result modification instruction is acquired according to the following steps:
in response to receiving the generation stopping instruction, displaying content processing identifiers under different question dimensions, the content processing identifier under each question dimension being used for guiding and pointing out a content question of the generated result content currently displayed under the question dimension; and
in response to triggering any of the content processing identifiers, acquiring the target content question under the question dimension corresponding to the content processing identifier, and generating the answer result modification instruction according to the target content question.

10. The computer device according to claim 8, wherein the answer result modification instruction is acquired according to the following steps:
acquiring inputted content modification information, and determining a question dimension and a target content question according to the content modification information; and
generating an answer result modification instruction according to the question dimension and the target content question.

11. The computer device according to claim 9, wherein the question dimension comprises a question understanding dimension, and the content processing identifier comprises a first processing identifier under the question understanding dimension;
the acquiring the target content question under the question dimension corresponding to the content processing identifier comprises:
displaying the questioning information in a dialog box of the dialog page;
acquiring edited updated questioning information in response to an editing operation for the questioning information in the dialog box; and
taking the updated questioning information as the target content question under the question understanding dimension.

12. The computer device according to claim 9, wherein the question dimension comprises a content error dimension for the answer content, and the content processing identifier comprises a second processing identifier under the content error dimension;
the acquiring the target content question under the question dimension corresponding to the content processing identifier comprises:
acquiring inputted error content information according to first error input prompt information in the dialog box of the dialog page, and determining a target content question according to the error content information and the content error dimension.

13. The computer device according to claim 9, wherein the question dimension comprises a content redundancy dimension for the answer content, and the content processing identifier comprises a third processing identifier under the content redundancy dimension;
the acquiring the target content question under the question dimension corresponding to the content processing identifier comprises:
acquiring a content redundancy question under the content redundancy dimension, and taking the content redundancy question as a target content question under the content redundancy dimension;
the displaying an updated answer result comprises:
displaying a default answer result, the default answer result being pre-generated for the content redundancy question; and
displaying the generated result content in the updated answer result according to a generation progress of the updated answer result, the generated result content in the updated answer result being obtained by performing content simplification on the answer result according to the content redundancy question.

14. The computer device according to claim 9, wherein before displaying the updated answer result, the method further comprises:
displaying preset answer information matched with the triggered content processing identifier below the displayed generated result content.

15. A non-transient computer-readable storage medium, wherein the non-transient computer-readable storage medium has stored thereon a computer program, and when the computer program is run by a computer device, the computer device executes a method for displaying information, which comprises:
in response to receiving questioning information on a dialog page, displaying a generated result content in an answer result matched with the questioning information according to a generation progress of the answer result;
in a process of displaying the generated result content, stopping generating the answer result in response to receiving a generation stopping instruction; and
in response to acquiring an answer result modification instruction, displaying an updated answer result, the updated answer result being obtained by modifying the answer result according to a target content question under a question dimension indicated by the answer result modification instruction.

16. The method according to claim 15, wherein the answer result modification instruction is acquired according to the following steps:
in response to receiving the generation stopping instruction, displaying content processing identifiers under different question dimensions, the content processing identifier under each question dimension being used for guiding and pointing out a content question of the generated result content currently displayed under the question dimension; and
in response to triggering any of the content processing identifiers, acquiring the target content question under the question dimension corresponding to the content processing identifier, and generating the answer result modification instruction according to the target content question.

17. The method according to claim 15, wherein the answer result modification instruction is acquired according to the following steps:
acquiring inputted content modification information, and determining a question dimension and a target content question according to the content modification information; and
generating an answer result modification instruction according to the question dimension and the target content question.

18. The method according to claim 16, wherein the question dimension comprises a question understanding dimension, and the content processing identifier comprises a first processing identifier under the question understanding dimension;
the acquiring the target content question under the question dimension corresponding to the content processing identifier comprises:
displaying the questioning information in a dialog box of the dialog page;
acquiring edited updated questioning information in response to an editing operation for the questioning information in the dialog box; and
taking the updated questioning information as the target content question under the question understanding dimension.

19. The method according to claim 16, wherein the question dimension comprises a content error dimension for the answer content, and the content processing identifier comprises a second processing identifier under the content error dimension;
the acquiring the target content question under the question dimension corresponding to the content processing identifier comprises:
acquiring inputted error content information according to first error input prompt information in the dialog box of the dialog page, and determining a target content question according to the error content information and the content error dimension.

20. The method according to claim 16, wherein the question dimension comprises a content redundancy dimension for the answer content, and the content processing identifier comprises a third processing identifier under the content redundancy dimension;
the acquiring the target content question under the question dimension corresponding to the content processing identifier comprises:
acquiring a content redundancy question under the content redundancy dimension, and taking the content redundancy question as a target content question under the content redundancy dimension;
the displaying an updated answer result comprises:
displaying a default answer result, the default answer result being pre-generated for the content redundancy question; and
displaying the generated result content in the updated answer result according to a generation progress of the updated answer result, the generated result content in the updated answer result being obtained by performing content simplification on the answer result according to the content redundancy question.
